(19) United States
(12) Patent Application Publication
(10) Pub. No.: US 2009/0139553 A1
(43) Pub. Date: Jun. 4, 2009

(54) DISHWASHER

(76) Inventor: Nung Seo PARK, Changwon-si (KR)

Correspondence Address: KED & ASSOCIATES, LLP, P.O. Box 221200, Chantilly, VA, 20153-1200, US

(21) Appl. No.: 12/254,994

(22) Filed: Oct. 21, 2008

(30) Foreign Application Priority Data
Oct. 22, 2007 (KR) 10-2007-106226

(51) Int. Cl. A47L 15/42; F16K 5/00

(52) U.S. Cl. 134/176; 251/304

(57) ABSTRACT

Disclosed is a dishwasher, which reduces a pressure loss generated from a valve device to converting a channel. The dishwasher includes a washing tub to wash dishes; a sump installed under the washing tub to store washing water; a pump assembly installed at one side of the sump to pump the washing water; upper and lower channels connected to the pump assembly; and upper and lower spray arms connected to the upper and lower channels to spray the washing water to the inside of the washing tub, and a valve device rotated around a rotary shaft parallel with the flowing direction of the washing water to selectively open the upper and lower channels is provided between the pump assembly and the upper and lower channels.

This application claims the benefit of Korean Patent Application No. 10-2007-0106226, filed on Oct. 22, 2007, which is hereby incorporated by reference as if fully set forth herein.

### BACKGROUND OF THE INVENTION

1. Field of the Invention

The present invention relates to a dishwasher, and more particularly, to a dishwasher having a valve device to convert a washing water channel.

2. Discussion of the Related Art

Dishwashers are electric home appliances for kitchens, which separate residue of food, such as grains of boiled rice, from dishes using high-pressure washing water, and thus wash the dishes.

In general, a dishwasher includes a washing tub provided with a cavity having a hexahedral shape in a main body, the front surface of which is opened, and a door installed on the front surface of the main body such that the door can be opened and closed.

Upper and lower racks are installed in the washing tub, and upper and lower spray arms to spray washing water onto dishes loaded on the racks are rotatably installed above or below the respective racks.

A sump storing the washing water is installed under the washing tub. A pump assembly to pump and supply the washing water to the upper and lower spray arms, and upper and lower channels to connect the pump assembly and the upper and lower spray arms are provided in the sump.

The sump includes a water supply valve to intermit the washing water supplied to the inside of the sump and a drain pump to drain the washing water in the sump to the outside installed at one side of the sump. The sump further includes a filter to filter out impurities from the washing water supplied from the upper washing tub to the inside of the sump.

The upper and lower spray arms are connected to the pump assembly installed at one side of the sump and the upper and lower channels provided in the pump assembly. Therefore, the pump assembly is operated and thus supplies the washing water in the sump to the upper and lower spray arms along the upper and lower channels. The washing water supplied to the upper and lower spray arms is sprayed onto the dishes loaded on the racks, and thus washes the dishes.

A valve device, which selectively opens and closes the upper and lower channels such that the washing water can be selectively supplied to the upper and lower channels, is provided at the connection part between the upper and lower channels and the pump assembly.

Korean Patent Laid-open Publication No. 10-2004-0047017 discloses a valve device, which opens and closes upper and lower channels.

The conventional valve device includes a case provided with an inlet, through which washing water is supplied from a sump to the valve device, and upper and lower outlets, through which the washing water is discharged to the upper and lower channels, and a valve having a cut cylindrical shape installed at a branched portion of the upper and lower channels to selectively open and close the inlet and the upper and lower outlets.

Here, the valve has a cut cylindrical shape, and a rotary shaft of the valve is installed perpendicularly to the flowing direction of the washing water.

Thus, the valve is affected by the hydraulic pressure of the washing water flowing in the valve device. Thereby, the valve moves from the center of the rotary shaft provided with hinged upper and lower ends to a designated displacement. As the valve moves to the designated displacement, as described above, a gap between the valve and the case is generated, and the washing water flows to the gap, thus causing a pressure loss of the washing water in the valve device.

Further, when the valve moves from the center of the rotary shaft to an excessively large displacement, the external surface of the valve contacts the internal surface of the case. The contact between the valve and the case disturbs the rotation of the valve and thus causes the malfunction of the valve device.

### SUMMARY OF THE INVENTION

Accordingly, the present invention is directed to a dishwasher.

One object of the present invention is to provide a dishwasher having an improved valve device to selectively open and close upper and lower channels.

To achieve this object and other advantages and in accordance with the purpose of the invention, as embodied and broadly described herein, a dishwasher includes a washing tub to wash dishes; a sump installed under the washing tub to store washing water; a pump assembly installed at one side of the sump to pump the washing water; upper and lower channels connected to the pump assembly; and upper and lower spray arms respectively connected to the upper and lower channels to spray the washing water to the inside of the washing tub, wherein a valve device rotated around a rotary shaft parallel with the flowing direction of the washing water to selectively open the upper and lower channels is provided between the pump assembly and the upper and lower channels.

Preferably, the valve device includes a case including an inlet connected to the pump assembly, and first and second outlets respectively connected to the upper and lower channels; and a valve rotatably provided in the case to selectively open and close the first and second outlets.

Preferably, the case includes a guide channel extended from the inlet such that the washing water flows in the guide channel; and a branch channel extended from the guide channel and formed at a position corresponding to the first and second outlets.

Preferably, the case further includes a valve receiving part provided above the branch channel to receive the valve to guide the rotation of the valve.

Preferably, the valve is installed in the branch channel to open and close at least one of the first and second outlets.

Preferably, the valve includes a first valve hole having the same size of the first outlet; and a second valve hole having the same size of the second outlet.

Preferably, any one pair of a pair of the first valve hole and the first outlet and a pair of the second valve hole and the second outlet coincides with each other according to the rotation of the valve so as to selectively open and close the first outlet and the second outlet.

Preferably, the valve further includes a first extension hole extended from the first valve hole and a second extension hole extended from the second valve hole, and thus the first outlet and the second outlet are simultaneously opened according to the rotation of the valve.

Preferably, the valve includes one valve hole to selectively open and close the first outlet and the second outlet according to the rotation of the valve.

Preferably, the case is formed by connecting a lower case provided with the inlet and an upper case provided with the first outlet and the second outlet.

In another aspect of the present invention, A valve device includes a case including an inlet, through which the washing water is supplied to the valve device, and first and second outlets, through which branched washing water is discharged to the outside; and a valve rotatably provided in the case, and rotated around a rotary shaft parallel with the flowing direction of the washing water to divisionally supply the washing water.

Preferably, the case includes a guide channel extended from the inlet such that the washing water flows in the guide channel; and a branch channel extended from the guide channel and formed at a position corresponding to the first and second outlets.

Preferably, the case further includes a valve receiving part provided above the branch channel to receive the valve to guide the rotation of the valve.

Preferably, the valve is installed in the branch channel to open and close at least one of the first and second outlets.

Preferably, the valve includes a first valve hole having the same size of the first outlet; and a second valve hole having the same size of the second outlet.

Preferably, any one pair of a pair of the first valve hole and the first outlet and a pair of the second valve hole and the second outlet coincides with each other according to the rotation of the valve so as to selectively open and close the first outlet and the second outlet.

Preferably, the valve further includes a first extension hole extended from the first valve hole and a second extension hole extended from the second valve hole, and thus the first outlet and the second outlet are simultaneously opened according to the rotation of the valve.

Preferably, the valve includes one valve hole to selectively open and close the first outlet and the second outlet according to the rotation of the valve.

Preferably, the case is formed by connecting a lower case provided with the inlet and an upper case provided with the first outlet and the second outlet.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a perspective view illustrating a dishwasher in accordance with the present invention;

FIG. 2 is a longitudinal-sectional view illustrating the internal structure of the dishwasher in accordance with the present invention;

FIG. 3 is an exploded view illustrating a valve device in accordance with one embodiment of the present invention;

FIG. 4 is a longitudinal-sectional view illustrating the internal structure of the valve device in accordance with one embodiment of the present invention;

FIGS. 5 and 6 are schematic views illustrating the operation of the valve device in accordance with one embodiment of the present invention;

FIG. 7 is an exploded view illustrating a valve device in accordance with another embodiment of the present invention;

FIG. 8 is an exploded view illustrating a valve device in accordance with yet another embodiment of the present invention; and

FIGS. 9 to 11 are schematic views illustrating the operation of the valve device in accordance with yet another embodiment of the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

Hereinafter, a dishwasher in accordance with a preferred embodiment of the present invention will be described in detail with reference to accompanying drawings.

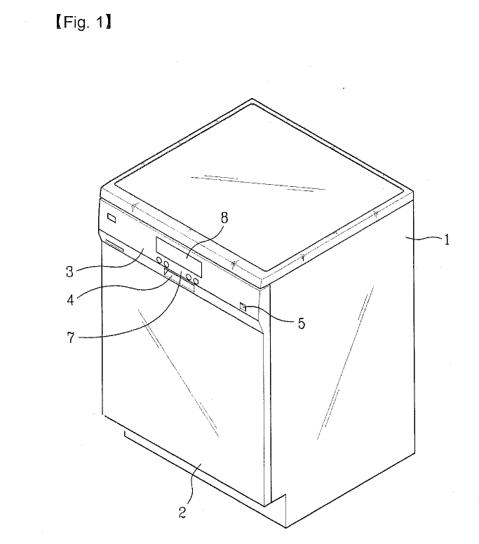

FIG. 1 is a perspective view illustrating a dishwasher in accordance with the present invention.

With reference to FIG. 1, the dishwasher of the present invention includes a case 1 forming the external appearance of the dishwasher and provided with the opened front surface, a door 2 to open and close the case 1, and a control panel 3 provided above the door 2 to display and control the operation of the dishwasher.

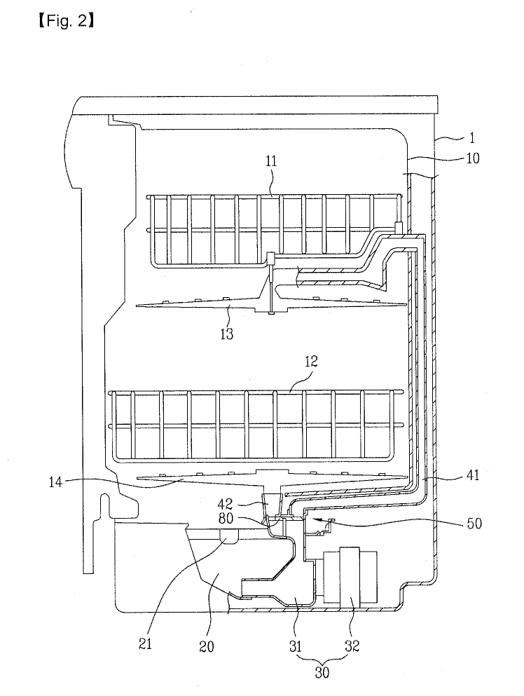

FIG. 2 is a longitudinal-sectional view illustrating the internal structure of the dishwasher in accordance with the present invention.

With reference to FIG. 2, the internal structure of the dishwasher of the present invention will be described.

The dishwasher includes a washing tub 10 forming a space, in which dishes are washed, in the case 1, and a sump 20 storing washing water to wash the dishes provided under the washing tub 10.

The washing tub 10 includes racks, which are slidably inserted into the washing tub 10 to collect dishes therein. Although this embodiment discloses two racks, i.e., an upper rack 11 and a lower rack 12, the racks may be formed in various shapes and numbers according to the size or capacity of the dishwasher.

Further, the washing tub 10 includes upper and lower spray arms 13 and 14 to respectively spray the washing water toward the upper rack 11 and the lower rack 12.

The sump 20 includes a water supply channel (not shown) to supply washing water to the inside of the sump 20, a water supply valve (not shown) to open and close the water supply channel, and a drain pump (not shown) to discharge the washing water from the sump 20 to the outside. The sump 20 further includes a filter 21 to filter out impurities from the washing water, which is circulated again from the washing tub 10 to the inside of the sump 20.

The sump 20 includes a pump assembly 30 to pump the washing water stored in the sump 20 toward the upper and lower spray arms 13 and 14, and a heater (not shown) to heat the washing water in the sump 20.

The pump assembly 30 includes a pump main body 31 connected to the sump 20 to form the channel of the washing water, and a wash pump 32 connected to the pump main body 30 to pump the washing water at a designated pressure.

The pump main body 31 of the pump assembly 30 includes upper and lower channels 41 and 42 connected to the upper and lower spray arms 13 and 14. Further, a valve device 50 to control the flow of the washing water to the upper and lower channels 41 and 42 via the pump main body 31 is provided between the pump main body 31 and the upper and lower channels 41 and 42.

The valve device 50 controls the washing water such that the supplied washing water selectively passes through the upper and lower channels 41 and 42, when the washing water in the sump 20 is supplied through the pump main body 31 by the operation of the wash pump 3.

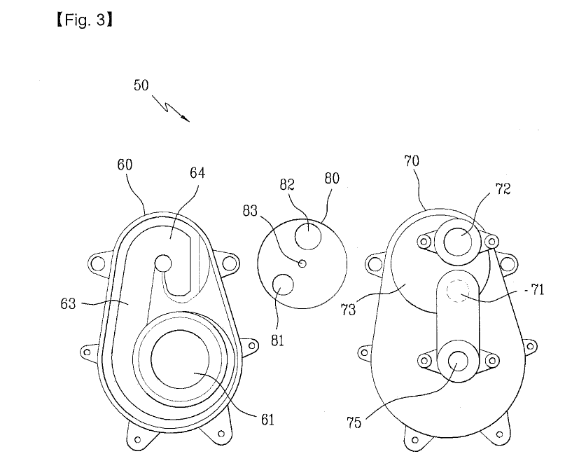

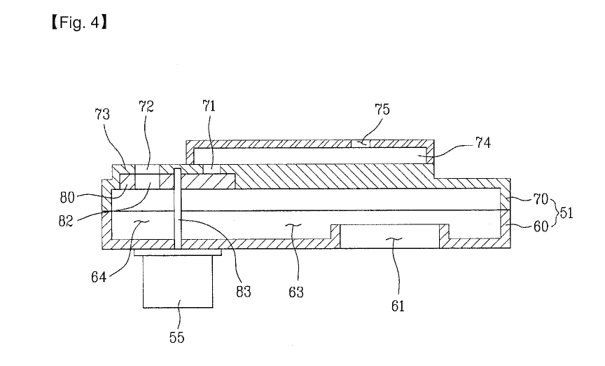

Hereinafter, a valve device in accordance with one embodiment of the present invention will be described in detail with reference to FIGS. 3 and 4.

FIG. 3 is an exploded view illustrating the valve device in accordance with one embodiment of the present invention, and FIG. 4 is a longitudinal-sectional view illustrating the internal structure of the valve device in accordance with one embodiment of the present invention.

As shown in FIGS. 3 and 4, the valve device 50 includes a lower case 60 including an inlet 61 connected to the pump main body 31 at the lower portion thereof and forming a channel, in which washing water is circulated, therein, an upper case 70 including first and second outlets 71 and 72 respectively connected to the upper and lower channels 41 and 42 at the upper portion thereof, a valve 80 installed between the upper case 70 and the lower case 60 to selectively connect the channel formed in the lower case 60 to the first and second outlets 71 and 72, and a motor 55 rotating the valve 80 to selectively open and close the first and second outlets 71 and 72.

The lower case 60 includes the inlet 61, through which the washing water supplied from the pump main body 31 is supplied to the lower case 60, a guide channel 63 extended from the inlet 61 such that the washing water flows in the guide channel 63, and a branch channel 64 extended from the guide channel 63 and formed at a position corresponding to the first and second outlets 71 and 72.

The upper case 70 includes a valve receiving part 73 formed at a position corresponding to the branch channel 64 of the lower case 60 such that the valve 80 is installed in the valve receiving part 73, the first outlet 71 formed at the outside of the valve receiving part 73 and connected to the upper channel 41, and the second outlet 72 connected to the lower channel 42.

The valve receiving part 73 forms a space, in which the valve 80 can rotate, and is formed in a depressed shape on the internal surface of the upper case 70. Preferably, the external surface of the valve receiving part 73 is separated from the internal surface of the valve 80 by a small interval such that the valve 80 received in the valve receiving part 73 can rotate.

The first outlet 71 is connected to the upper channel 41, to which the upper spray arm 13 is connected. The second outlet 72 is connected to the lower channel 42, to which the lower spray arm 14 is connected.

Preferably, the diameter of the first outlet 71 is smaller than that of the second outlet 72. The reason is that the cross-sectional area of the upper channel 41 is smaller than that of the lower channel 42 to maintain the amount and pressure of the washing water to supply the washing water up to the upper spray arm 13.

Additionally, in case that the upper channel 41 and the lower channel 42 are separated from each other by a designated distance, the upper case 70 further includes an extension channel 74 extended from the first outlet 71 (or the second outlet 72), and a connector 75 formed at one side of the extension channel 74 such that the upper channel 41 is connected to the connector 75.

The valve 80 is inserted into the valve receiving part 73, and is located between the branch channel 64 and the first and second outlets 71 and 72. The valve 80 has a disk shape, and is provided with a rotary shaft 83 at the center thereof. Further, first and second valve holes 81 and 82 are formed through the valve 80 at positions corresponding to the first and second outlets 71 and 72. The diameter of the first valve hole 81 has a size corresponding to the diameter of the first outlet 71, and the diameter of the second valve hole 82 has a size corresponding to the diameter of the second outlet 72.

Now, the positioning relation between the first and second valve holes 81 and 82 and the first and second outlets 71 and 72 will be described. The first and second valve holes 81 and 82 and the first and second outlets 71 and 72 are eccentrically located at one side of the center of rotation of the valve 80. Further, the first and second valve holes 81 and 82 and the first and second outlets 71 and 72 are located at positions corresponding to each other.

Thereby, the first and second valve holes 81 and 82 and the first and second outlets 71 and 72 can be connected to each other simultaneously or selectively according to the rotation of the valve 80.

The motor 55 is located under the lower case 60, and is connected to the rotary shaft 83 of the valve 80 and thus rotates the valve 80. Preferably, the motor 55 is a step motor in order to cause the first and second valve holes 81 and 82 and the first and second outlets 71 and 72 to coincide with each other.

Hereinafter, the operation of the dishwasher in accordance with the embodiment of the present invention will be described. Respective elements, which will be described later, will be understood with reference to the above description and drawings.

Further, in the description of the operation of the dishwasher of the present invention, the detailed description of the operation of the dishwasher will be omitted because it may make the subject matter of the present invention rather unclear, and thus the operation of only the valve device will be described in detail.

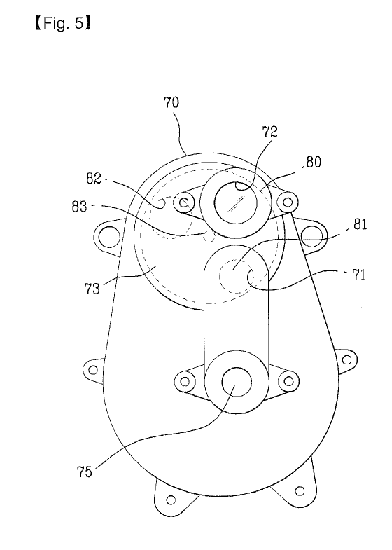

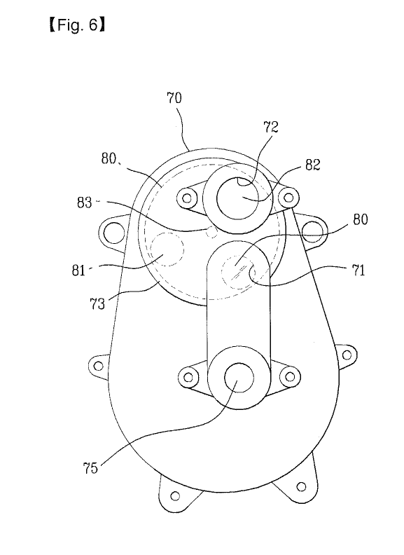

Hereinafter, the operation of the valve device 50 will be described with reference to FIGS. 5 and 6. FIGS. 5 and 6 are schematic views illustrating the operation of the valve device in accordance with one embodiment of the present invention.

The washing water stored in the sump 20 is supplied to the valve device 50 through the pump main body 31 of the pump assembly 30 according to the operation of the dishwasher.

In order to supply the washing water flowing into the valve device 50 to the upper spray arm 13, the motor 55 is rotated at a predetermined angle, and thus the first valve hole 81 of the valve 80 and the first outlet 71 of the upper case 70 coincide with each other, as shown in FIG. 5.

Then, the first valve hole 81 and the first outlet 71 are connected to each other, and the washing water flowing into the valve device 50 flows through the first outlet 71. The washing water flowing through the first outlet 71 is supplied to the upper spray arm 13 through the upper channel 41 connected to the first outlet 71. Thereby, the upper spray arm 13 discharges the washing water, thus washing dishes. Here, the second valve hole 82 of the valve 80 and the second outlet 72 of the upper case 70 are separated from each other, and thus the closed state of the second outlet 72 by the surface of the valve 80 is maintained.

On the other hand, in order to supply the washing water flowing into the valve device 50 to the lower spray arm 14, the motor 55 is rotated at a predetermined angle, and thus the second valve hole 82 of the valve 80 and the second outlet 72 of the upper case 70 coincide with each other, as shown in FIG. 6.

Then, the second valve hole 82 and the second outlet 72 are connected to each other, and the washing water flowing into the valve device 50 flows through the second outlet 72. The washing water flowing through the second outlet 72 is supplied to the lower spray arm 14 through the lower channel 42 connected to the second outlet 72. Thereby, the lower spray arm 14 discharges the washing water, thus washing dishes. Here, the first valve hole 81 of the valve 80 and the first outlet 71 of the upper case 70 are separated from each other, and thus the closed state of the first outlet 71 by the surface of the valve 80 is maintained (with reference to FIG. 6).

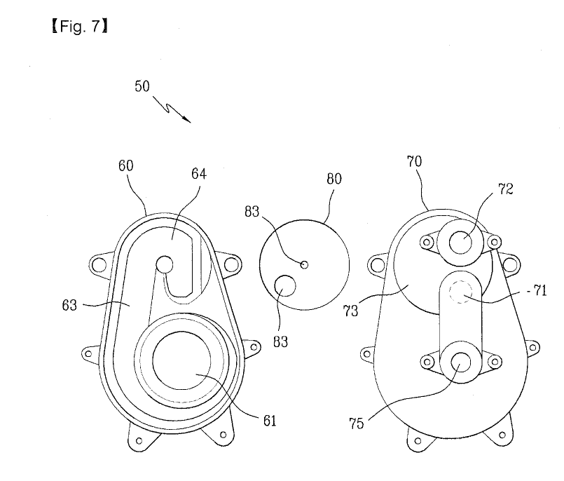

Hereinafter, a valve device in accordance with another embodiment of the present invention will be described. FIG. 7 is an exploded view illustrating a valve device in accordance with another embodiment of the present invention. The valve device of this embodiment has the same structure as that of the valve device of the earlier embodiment except for the structure of the valve 80. Thus, the description of other elements of the valve device of this embodiment except for the valve 80 will be omitted.

The valve device 50 of this embodiment differs from the valve device of the earlier embodiment in that one valve hole 85 is formed through the valve 80 and the sizes of the first and second outlets 71 and 72 are equal to that of the valve hole 85.

In the valve device 50 in accordance with this embodiment, the upper channel 41 and the lower channel 42 are selectively opened and closed according to the position of the valve hole 85 corresponding to any one of the first and second outlets 71 and 72.

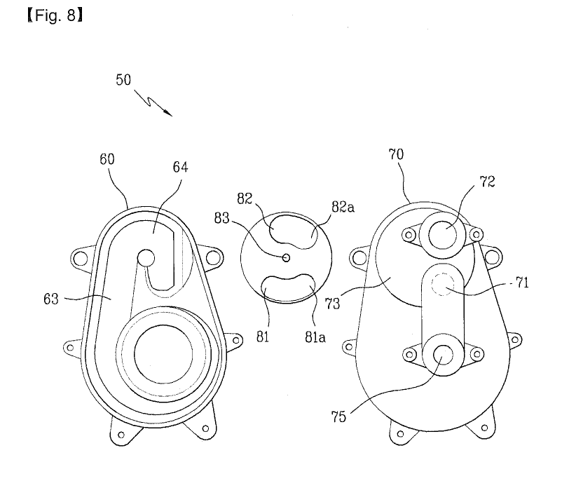

Hereinafter, a valve device in accordance with yet another embodiment of the present invention will be described. FIG. 8 is an exploded view illustrating a valve device in accordance with yet another embodiment of the present invention. The valve device of this embodiment has the same structure as that of the valve device of the earlier embodiment except for the structure of the valve 80. Thus, the description of other elements of the valve device of this embodiment except for the valve 80 will be omitted.

The valve 80 of the valve device 50, as shown in FIG. 8, includes first and second valve holes 81 and 82, and first and second extension holes 81a and 82a respectively extended from the first and second valve holes 81 and 82 and formed at positions corresponding to the first and second outlets 71 and 72. Thereby, in the valve device 50 in accordance with this embodiment, the upper channel 41 and the lower channel 42 are selectively or simultaneously opened and closed.

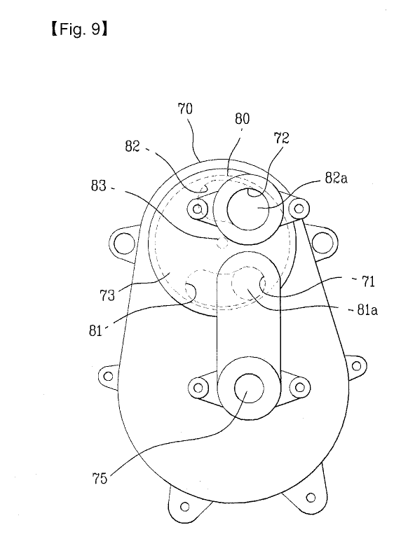

Hereinafter, the operation of the valve device in accordance with yet another embodiment of the present invention will be described. FIGS. 9 to 11 are schematic views illustrating the operation of the valve device in accordance with yet another embodiment of the present invention.

FIG. 9 illustrates the valve device in a state that the upper channel 41 and the lower channel 42 are simultaneously opened. In order to simultaneously open the upper channel 41 and the lower channel 42, the motor 55 rotates the valve 80, and thus the first extension hole 81a and the second extension hole 82a respectively coincide with the first outlet 71 and the second outlet 72. Since the first extension hole 81a coincides with the first outlet 71 and the second extension hole 82a coincides with the second outlet 72, as described above, washing water is supplied to the upper channel 41 and the lower channel 42 simultaneously.

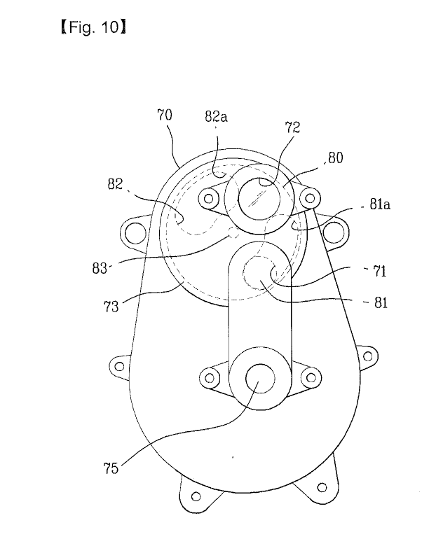

FIG. 10 illustrates the valve device in a state that only the upper channel 41 is opened. In order to open only the upper channel 41, the motor 55 rotates the valve 80, and thus the first valve hole 81 coincides with the first outlet 71. Herein, the second outlet 72 is closed by the valve 80, and thus washing water is not supplied to the lower channel 42.

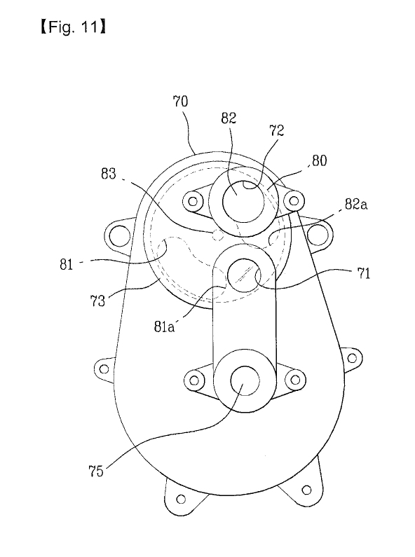

FIG. 11 illustrates the valve device in a state that only the lower channel 42 is opened. In order to open only the lower channel 42, the motor 55 rotates the valve 80, and thus the second valve hole 82 coincides with the second outlet 72. Herein, the first outlet 71 is closed by the valve 80, and thus washing water is not supplied to the upper channel 41.

As described above, in the valve device of the present invention, the valve is installed such that the direction of force applied to the valve by the washing water coincides with the axial direction of the rotary shaft, thus reducing a pressure loss generated from the valve device. Further, the deformation of the valve due to hydraulic pressure is prevented, and thus the malfunction of the valve is prevented.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A dishwasher comprising:
a washing tub to wash dishes;
a sump installed under the washing tub to store washing water;
a pump assembly installed at one side of the sump to pump the washing water;
upper and lower channels connected to the pump assembly; and
upper and lower spray arms respectively connected to the upper and lower channels to spray the washing water to the inside of the washing tub,
wherein a valve device rotated around a rotary shaft parallel with the flowing direction of the washing water to selectively open the upper and lower channels is provided between the pump assembly and the upper and lower channels.

2. The dishwasher according to claim 1, wherein the valve device includes:
a case including an inlet connected to the pump assembly, and first and second outlets respectively connected to the upper and lower channels; and
a valve rotatably provided in the case to selectively open and close the first and second outlets.

3. The dishwasher according to claim 2, wherein the case includes:
a guide channel extended from the inlet such that the washing water flows in the guide channel; and
a branch channel extended from the guide channel and formed at a position corresponding to the first and second outlets.

4. The dishwasher according to claim 3, wherein the case further includes a valve receiving part provided above the branch channel to receive the valve to guide the rotation of the valve.

5. The dishwasher according to claim 3, wherein the valve is installed in the branch channel to open and close at least one of the first and second outlets.

6. The dishwasher according to claim 5, wherein the valve includes:
a first valve hole having the same size of the first outlet; and
a second valve hole having the same size of the second outlet.

7. The dishwasher according to claim 6, wherein any one pair of a pair of the first valve hole and the first outlet and a pair of the second valve hole and the second outlet coincides with each other according to the rotation of the valve so as to selectively open and close the first outlet and the second outlet.

8. The dishwasher according to claim 6, wherein the valve further includes a first extension hole extended from the first valve hole and a second extension hole extended from the second valve hole, and thus the first outlet and the second outlet are simultaneously opened according to the rotation of the valve.

9. The dishwasher according to claim 5, wherein the valve includes one valve hole to selectively open and close the first outlet and the second outlet according to the rotation of the valve.

10. The dishwasher according to claim 2, wherein the case is formed by connecting a lower case provided with the inlet and an upper case provided with the first outlet and the second outlet.

11. A valve device for divisionally supplying washing water of a dishwasher, comprising:
a case including an inlet, through which the washing water is supplied to the valve device, and first and second outlets, through which branched washing water is discharged to the outside; and
a valve rotatably provided in the case, and rotated around a rotary shaft parallel with the flowing direction of the washing water to divisionally supply the washing water.

12. The valve device according to claim 11, wherein the case includes:
a guide channel extended from the inlet such that the washing water flows in the guide channel; and
a branch channel extended from the guide channel and formed at a position corresponding to the first and second outlets.

13. The valve device according to claim 12, wherein the case further includes a valve receiving part provided above the branch channel to receive the valve to guide the rotation of the valve.

14. The valve device according to claim 12, wherein the valve is installed in the branch channel to open and close at least one of the first and second outlets.

15. The valve device according to claim 14, wherein the valve includes:
a first valve hole having the same size of the first outlet; and
a second valve hole having the same size of the second outlet.

16. The valve device according to claim 15, wherein any one pair of a pair of the first valve hole and the first outlet and a pair of the second valve hole and the second outlet coincides with each other according to the rotation of the valve so as to selectively open and close the first outlet and the second outlet.

17. The valve device according to claim 15, wherein the valve further includes a first extension hole extended from the first valve hole and a second extension hole extended from the second valve hole, and thus the first outlet and the second outlet are simultaneously opened according to the rotation of the valve.

18. The valve device according to claim 14, wherein the valve includes one valve hole to selectively open and close the first outlet and the second outlet according to the rotation of the valve.

19. The valve device according to claim 11, wherein the case is formed by connecting a lower case provided with the inlet and an upper case provided with the first outlet and the second outlet.
